(19) United States
(12) Patent Application Publication
(10) Pub. No.: US 2026/0362419 A1
(43) Pub. Date: Nov. 12, 2026

(54) COMMUNICATION APPARATUS, COMMUNICATION TERMINAL, COMMUNICATION SYSTEM, COMMUNICATION METHOD, AND PROGRAM

(71) Applicant: NEC Corporation, Minato-ku, Tokyo (JP)

(72) Inventor: Takahiro SASAKI, Tokyo (JP)

(73) Assignee: NEC Corporation, Minato-ku, Tokyo (JP)

(21) Appl. No.: 19/119,846

(22) PCT Filed: Oct. 10, 2023
(86) PCT No.: PCT/JP2023/036667

§ 371 Date: Apr. 10, 2025

(30) Foreign Application Priority Data
Oct. 26, 2022 (JP) 2022-171841

(51) Int. Cl. H04W 72/1273; H04W 72/0446

(52) U.S. Cl. CPC H04W 72/1273; H04W 72/0446

(57) ABSTRACT

An object is to provide a communication apparatus capable of reducing the load of PDCCH monitoring processing. A communication apparatus according to the present disclosure includes a control unit configured to determine, by using a slot length of a slot included in a radio frame and a frame rate of data, a first period with the slot used as a unit and a second period with a symbol included in the slot used as a unit, and determine, by using the first period and the second period, a symbol number for transmitting scheduling information of the data, and a communication unit configured to transmit the first period and a value related to the second period to a communication terminal.

### TECHNICAL FIELD

The present disclosure relates to a communication apparatus, a communication terminal, a communication system, a communication method, and a program.

### BACKGROUND ART

In 3rd Generation Partnership Project (3GPP), which defines a wireless communication standard, 5th Generation (5G) has been studied. 5G may be referred to as NR (New Radio). In NR, a downlink data channel received by user equipment (UE) or an uplink data channel transmitted by the UE is scheduled by using downlink control information (DCI). The DCI is transmitted from a base station to the UE using a physical downlink control channel (PDCCH). Here, the UE is used as a general term for terminals in 3GPP. Furthermore, the base station may be referred to as an access network node, a gNB (g Node B), or the like.

For example, Non Patent Literature 1 discloses processing related to monitoring of the PDCCH in NR. Specifically, the UE determines a PDCCH monitoring occasion in an active downlink bandwidth part (DL BWP). The PDCCH monitoring occasion is indicated by using any slot number among a plurality of slots constituting the frame. The UE monitors PDCCH candidates using consecutive T (T is an integer) slots as a search space from the slot number indicating the PDCCH monitoring occasion.

Non Patent Literature 1 also discloses that the UE monitors the PDCCH in a specific symbol. Specifically, the UE is instructed by monitoringSymbols WithinSlot to monitor the PDCCH in three consecutive symbols in all slots monitored by the UE.

Non Patent Literature 2 discloses that monitoringSymbols WithinSlot is indicated as a bitmap of 14 bits included in one slot. Each bit indicates an OFDM symbol. The UE attempts to receive the PDCCH in the symbol corresponding to the bit in which “1” is set. Receiving the PDCCH may be paraphrased as detecting the PDCCH. The UE can receive or detect the DCI by receiving the PDCCH.

### CITATION LIST

### Non Patent Literature

Non Patent Literature 1: 3GPP TS 38.213 V17.3.0 (2022-09)
Non Patent Literature 2: 3GPP TS 38.331 V17.1.0 (2022-06)

### SUMMARY OF INVENTION

### Technical Problem

Here, the base station needs to schedule the PDCCH in accordance with a time when data to be transmitted to the UE or data to be transmitted by the UE is generated. For example, in a case where the frame rate of the data transmitted from the base station to the UE is 120 Hz, the update interval of the frame is 8.333 ms (milliseconds). The base station performs scheduling in units of slot lengths. For example, if the slot length is 1 ms, the base station needs to schedule the PDCCH at intervals of 9 ms or 8 ms. In such a situation, in a case where the PDCCH monitoring processing disclosed in Non Patent Literature 1 is used, the UE needs to monitor the PDCCH in all the slots every 1 ms in order to detect the PDCCH that may be scheduled at different intervals. Therefore, there is a problem that the power consumption associated with the PDCCH monitoring processing in the UE increases.

Similarly, in a case where the PDCCH monitoring processing disclosed in Non Patent Literature 2 is performed, it is necessary to monitor the PDCCH at a specific symbol time in all slots. Therefore, there is a problem that processing power associated with the PDCCH monitoring processing in the UE increases.

In view of the above-described problems, an object of the present disclosure is to provide a communication apparatus, a communication terminal, a communication system, a communication method, and a program capable of reducing the load of PDCCH monitoring processing.

### Solution to Problem

A communication apparatus according to a first aspect of the present disclosure includes a control unit configured to determine, by using a slot length of a slot included in a radio frame and a frame rate of data (or data arrival rate), a first period with the slot used as a unit and a second period with a symbol included in the slot used as a unit, and determine, by using the first period and the second period, a symbol number for transmitting scheduling information of the data, and a communication unit configured to transmit the first period and a value related to the second period to a communication terminal.

A communication terminal according to a second aspect of the present disclosure includes a communication unit configured to receive a first period with a slot included in a radio frame used as a unit and a value related to a second period with a symbol included in the slot as a unit, and a control unit configured to determine, by using the first period and the second period specified on a basis of the value related to the second period, a symbol number for receiving scheduling information of data. The communication unit receives the scheduling information in the symbol number.

A communication system according to a third aspect of the present disclosure includes a communication apparatus including a communication unit configured to determine, by using a slot length of a slot included in a radio frame and a frame rate of data, a first period with the slot used as a unit and a second period with a symbol included in the slot used as a unit, determine, by using the first period and the second period, a symbol number for transmitting scheduling information of the data, and transmit the first period and a value related to the second period, and a communication terminal configured to receive the first period and the value related to the second period, determine, by using the first period and the second period specified on a basis of the value related to the second period, the symbol number for receiving the scheduling information of the data, and receive the scheduling information in the symbol number.

A communication method according to a fourth aspect of the present disclosure is executed in a communication apparatus. The communication apparatus determines, by using a slot length of a slot included in a radio frame and a frame rate of data, a first period with the slot used as a unit and a second period with a symbol included in the slot used as a unit, determines, by using the first period and the second period, a symbol number for transmitting scheduling information of the data, and transmits the first period and a value related to the second period to a communication terminal.

A program according to a fifth aspect of the present disclosure is configured to cause a computer to execute receiving a first period with a slot included in a radio frame used as a unit and a value related to a second period with a symbol included in the slot as a unit, determining, by using the first period and the second period specified on a basis of the value related to the second period, a symbol number for receiving scheduling information of data, and receiving the scheduling information in the symbol number.

### Advantageous Effects of Invention

According to the present disclosure, it is possible to provide a communication apparatus, a communication terminal, a communication system, a communication method, and a program capable of reducing the load of PDCCH monitoring processing.

### BRIEF DESCRIPTION OF DRAWINGS

FIG. 1 is a configuration diagram of a communication apparatus according to the present disclosure.

FIG. 2 is a diagram illustrating a configuration of a radio frame according to the present disclosure.

FIG. 3 is a configuration diagram of a communication terminal according to the present disclosure.

FIG. 4 is a flowchart illustrating communication processing executed in the communication apparatus according to the present disclosure.

FIG. 5 is a flowchart illustrating communication processing executed in the communication terminal according to the present disclosure.

FIG. 6 is a configuration diagram of a communication system according to the present disclosure.

FIG. 7 is a flowchart illustrating a procedure of communication processing between a UE and a gNB according to the present disclosure.

FIG. 8 is a diagram describing a search space according to the present disclosure.

FIG. 9 is a diagram describing a search space according to the present disclosure.

FIG. 10 is a flowchart illustrating a procedure of processing of determining the search space in the UE according to the present disclosure.

FIG. 11 is a configuration diagram of the gNB according to the present disclosure.

FIG. 12 is a configuration diagram of the UE according to the present disclosure.

### EXAMPLE EMBODIMENT

### First Example Embodiment

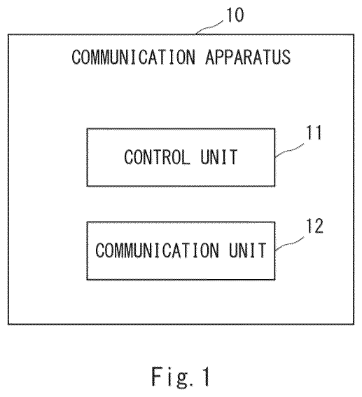

Next, a configuration example of a communication apparatus 10 will be described with reference to FIG. 1. The communication apparatus 10 may be a computer apparatus that operates in a case where a processor executes a program stored in a memory. The communication apparatus 10 may be an apparatus located in a mobile network, such as a base station or an access network node.

The communication apparatus 10 includes a control unit 11 and a communication unit 12. The control unit 11 and the communication unit 12 may be software components or modules whose processing is carried out by causing the processor to execute the program stored in the memory. Alternatively, the control unit 11 and the communication unit 12 may be hardware components such as circuits or chips.

The control unit 11 uses a slot length of a slot included in a radio frame and a frame rate of data to determine a first period in units of slots and a second period in units of symbols included in the slot. The control unit 11 also determines a symbol number for transmitting scheduling information of the data by using the first period and the second period.

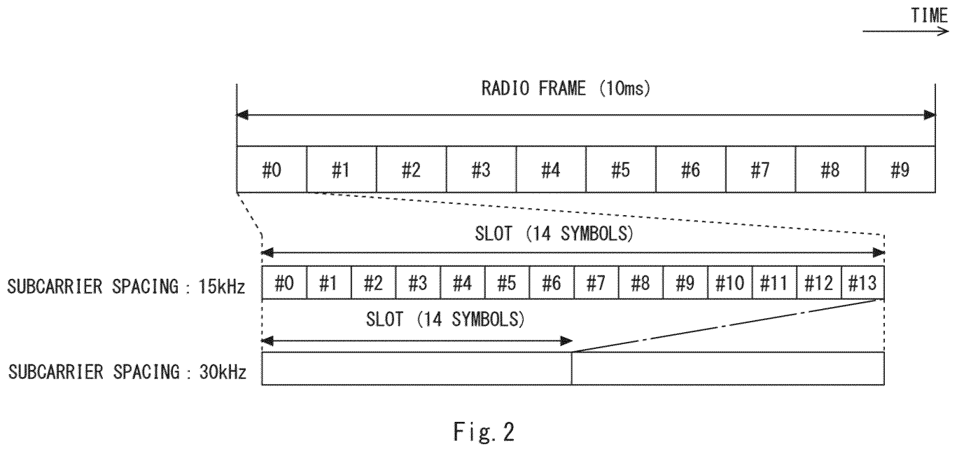

Here, an example of a configuration of the radio frame, the slot, and the symbol will be described with reference to FIG. 2. Since FIG. 2 is an example, the configuration of the radio frame, the slot, and the symbol is not limited to the configuration illustrated in FIG. 2, and can be any of various configurations.

FIG. 2 illustrates that one radio frame is 10 ms. Further, one radio frame includes 10 subframes. Further, FIG. 2 illustrates that one subframe corresponds to one slot or two slots. NR employs Orthogonal Frequency Division Multiplexing (OFDM) as in the case of Long Term Evolution (LTE). In addition, NR supports 15 kHz, which is the same subcarrier spacing as that of LTE, and further supports 30 kHz, 60 kHz, 120 kHz, and 240 kHz. Here, in a case where the subcarrier spacing is 15 kHz, one subframe corresponds to one slot, and in a case where the subcarrier spacing is 30 kHz, one subframe corresponds to two slots. In addition, in a case where the subcarrier spacing is 60 kHz, one subframe corresponds to four slots, in a case where the subcarrier spacing is 120 kHz, one subframe corresponds to eight slots, and in a case where the subcarrier spacing is 240 kHz, one subframe corresponds to 16 slots.

Further, FIG. 2 illustrates that one slot includes 14 symbols regardless of the subcarrier spacing. Alternatively, one slot may include 12 symbols. Here, the symbol may be an OFDM symbol.

Returning to FIG. 1, the frame rate of data used to determine the first period and the second period may be, for example, a frame rate of an image used in augmented reality (AR), virtual reality (VR), or the like. The frame rate of the image may be, for example, 60 Hz, 120 Hz, or 144 Hz. 60 Hz, 120 Hz, and 144 Hz have the same meanings as 60 frames per second (fps), 120 fps, and 144 fps, respectively. In a case where the frame rates are 60 Hz, 120 Hz, and 144 Hz, the update intervals of the frame (or data) are 16.666 ms, 8.333 ms, and 6.944 ms.

Since the first period is expressed in units of slot lengths, for example, the first period may be expressed as an integral multiple of 1 ms. In addition, since the second period is expressed in units of symbol lengths, for example, the second period may be expressed as an integral multiple of 1 ms/14 (“/” indicates division). The first period is longer than the second period.

The symbol number may be determined using, for example, a serial number in the first period, or may be determined as a b-th symbol of an a-th slot (a and b are integers of 1 or more). The data may be, for example, image data or the like, and may be, for example, U (User)-plane data transmitted via a physical downlink shared channel (PDSCH), a physical uplink shared channel (PUSCH), or the like. In addition, the scheduling information may be referred to as C (Control)-plane data transmitted via the PDCCH. The scheduling information corresponds to the DCI transmitted via the PDCCH.

The communication unit 12 transmits the first period and a value related to the second period to a communication terminal. The value related to the second period may be a value indicating the second period or a value used to calculate the second period. For example, the value related to the second period may be a value indicating the number of times for repeating the period in units of symbols in the first period. Alternatively, the value related to the second period may be a value indicating a ratio of the second period to the first period.

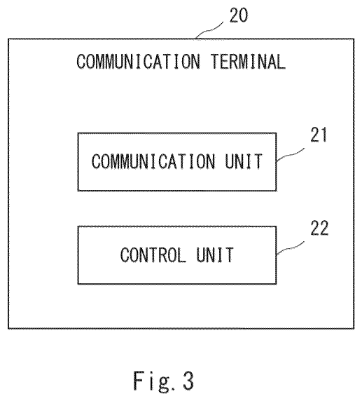

Next, a configuration example of a communication terminal 20 will be described with reference to FIG. 3. The communication terminal 20 may be a computer apparatus that operates in a case where a processor executes a program stored in a memory. The communication terminal 20 may be, for example, an apparatus that performs wireless communication with the communication apparatus 10. The communication terminal 20 may be a mobile phone terminal, a smartphone terminal, a head mounted display (HMD) as a wearable device, an Internet of Things (IoT) terminal, a machine type communication (MTC) terminal, a digital signage, or the like. In addition, the communication terminal 20 may be a UE used as a general term for terminals in 3GPP.

The communication terminal 20 includes a communication unit 21 and a control unit 22. The communication unit 21 and the control unit 22 may be software components or modules whose processing is carried out by causing the processor to execute the program stored in the memory.

The communication unit 21 receives the first period in units of slots included in the radio frame and the value related to the second period in units of symbols included in the slot. The communication unit 21 receives the first period and the value related to the second period by wireless communication.

The control unit 22 determines a symbol number for receiving scheduling information of data by using the first period and the second period specified on the basis of the value related to the second period. In a case where the communication unit 21 receives a value indicating the second period as the value related to the second period, the control unit 22 specifies the received value as the second period. In a case where the communication unit 21 receives a value used to calculate the second period as the value related to the second period, the control unit 22 calculates the second period on the basis of the received value.

The control unit 22 determines the symbol number for receiving the scheduling information of the data by using the first period and the second period.

The communication unit 21 receives the scheduling information set to the symbol number determined by the control unit 22. Receiving the scheduling information may be paraphrased as detecting the scheduling information. By receiving the scheduling information, the communication terminal 20 specifies a resource allocated to the data and enables reception of the data.

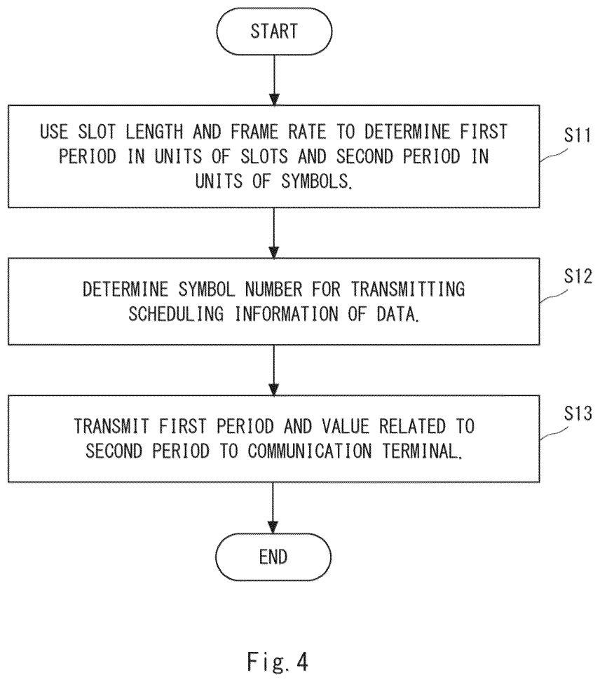

Next, a procedure of communication processing executed in the communication apparatus 10 will be described with reference to FIG. 4. First, the control unit 11 uses the slot length of the slot included in the radio frame and the frame rate of the data to determine the first period in units of slots and the second period in units of symbols included in the slot (S11).

Subsequently, the control unit 11 determines the symbol number for transmitting the scheduling information of the data by using the first period and the second period (S12). Subsequently, the communication unit 12 transmits the first period and the value related to the second period to the communication terminal (S13).

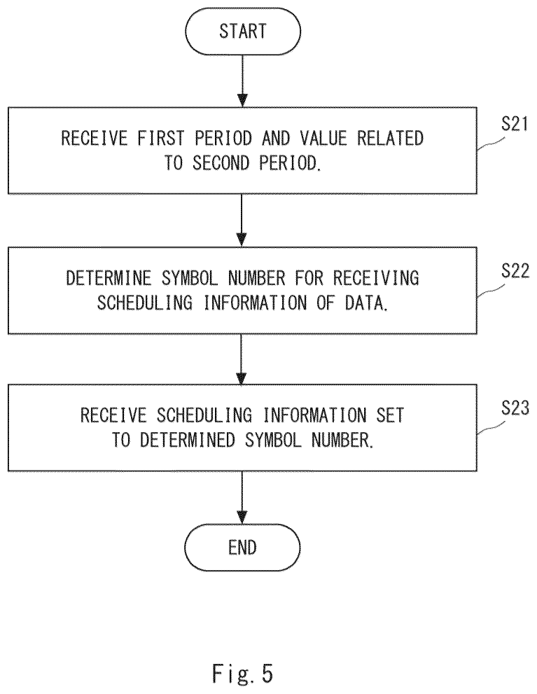

Next, a procedure of communication processing executed in the communication terminal 20 will be described with reference to FIG. 5. First, the communication unit 21 receives the first period in units of slots included in the radio frame and the value related to the second period in units of symbols included in the slot (S21).

Subsequently, the control unit 22 determines the symbol number for receiving the scheduling information of the data by using the first period and the second period specified on the basis of the value related to the second period (S22). Subsequently, the communication unit 21 receives the scheduling information set to the symbol number determined by the control unit 22 (S23).

As described above, the communication apparatus 10 determines the first period in units of slots and the second period in units of symbols. Further, the communication terminal 20 specifies the first period and the second period by using the first period and the value related to the second period. As a result, since the communication terminal 20 can execute the processing for receiving the scheduling information at the time indicated in the second period in units of symbols, it is not necessary to monitor all the slots in order to receive the scheduling information. As a result, the load of monitoring the scheduling information in the communication terminal 20 can be reduced.

### Second Example Embodiment

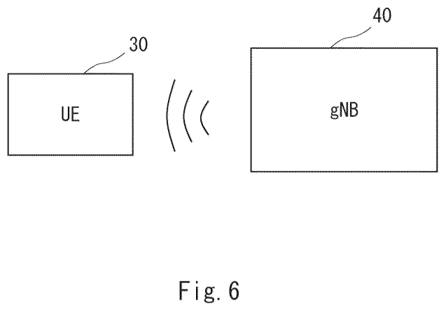

Next, a configuration example of a communication system will be described with reference to FIG. 6. A UE 30 corresponds to the communication terminal 20 in FIG. 3. A gNB 40 corresponds to the communication apparatus 10 in FIG. 1. The UE 30 and the gNB 40 support a communication scheme defined as 5G or NR in 3GPP.

Here, scheduling of the PDCCH in communication between the UE 30 and the gNB 40 will be described. The UE 30 monitors a set of PDCCH candidates in one or more control resource sets (CORESETs) on active DL BWPs. The CORESET is a set of control-resource elements for transmitting the PDCCH, and is defined by resource blocks in the frequency domain and symbols in the time domain. The active DL BWP indicates a BWP in the activated serving cell. The UE 30 monitors a search space, receives the PDCCH candidate, and further decodes the DCI.

The set of PDCCH candidates monitored by the UE 30 is determined in a PDCCH search space set. The PDCCH search space set may be referred to as a search space set or a search space. As the search space set, a common search space (CSS) set or a UE-specific search space (USS) set is defined. The UE 30 monitors the PDCCH candidates in the search space set determined according to the type of the PDCCH. The search space set determined according to the type of the PDCCH may be, for example, Type0-PDCCH CSS, Type0A-PDCCH CSS, TypeOB-PDCCH CSS, Type1-PDCCH CSS, Type1A-PDCCH CSS, Type2-PDCCH CSS, or Type3-PDCCH CSS. Different Types are used depending on the usage and application of the PDCCH. For example, Type0 may be used to decode system information block (SIB) 1, and TypeOA may be used to decode an SIB other than SIB1.

Here, the timing of the PDCCH monitored by the UE 30 may be determined by the following Equation 1.

$$( {n}_{f} \cdot {N}_{slot}^{frame , μ} + {n}_{s , f}^{μ} - {o}_{s} ) mod {k}_{s} = 0 \qquad ( Equation 1 )$$

kₛ: period (in units of slots)
oₛ: start slot of period kₛ (in units of slots)
n_{f}: radio frame number (0.1023)

$${N}_{slot}^{frame , μ} :$$

number of slots per radio frame

$${n}_{s , f}^{μ} :$$

slow number in the raio frame

$$( 0 … {N}_{slot}^{frame , μ} - 1 )$$

Tₛ: duration

The UE 30 starts with a slot of

$${n}_{s , f}^{μ} ,$$

out of the radio frame numbers n_{f} satisfying Equation 1, and defines the predetermined number of slots Tₛ as a search space set to monitor the PDCCH in the search space set. In other words, the UE 30 does not need to monitor the PDCCH in the slot determined by kₛ-Tₛ.

In addition, while Equation 1 is used to calculate a search space set in units of slots, the following Equation 2 may be used to calculate a search space set in units of symbols.

$$( ( ( {n}_{f} \cdot {N}_{slot}^{frame , μ} + {n}_{s , f}^{μ} - {o}_{s} ) mod {k}_{s} ) \cdot {N}_{symb}^{slot} + {n}_{symb , k}^{μ} - {o}_{symb} ) mod ⌈ {k}_{factor} \cdot {k}_{s} \cdot {N}_{symb}^{slot} ⌉ = 0 \qquad ( Equation 2 )$$

kₛ: period (in units of slots)
oₛ: period start position (offset in units of slots)
n_{f}: radio frame number (0.1023)

$${N}_{slot}^{frame , μ} :$$

number of slots per radio frame

$${n}_{s , f}^{μ} :$$

slot number with reference to head of radio frame

$${n}_{f} ( 0 … {N}_{slot}^{frame , μ} - 1 )$$

$${N}_{symb}^{slot} :$$

number of symbols per slot (14, or, 12)

$${n}_{symb , k}^{μ} :$$

symbol number in slot

$${n}_{s , f}^{μ} ( 0 … {N}_{symb}^{slot} - 1 )$$

k_{factor}: coefficient related to period such as ⅓
o_{symb}: offset in units of OFDM symbols

$$( 0 … {k}_{factor} \cdot {k}_{s} \cdot {N}_{symb}^{slot} - 1 )$$

T_{symb}: duration of PDCCH reception opportunity in units of symbols

The period kₛ in units of slots corresponds to the first period.

$$[ {k}_{factor} \cdot {k}_{s} \cdot {N}_{symb}^{slot} ]$$

corresponds to the second period, which is a period in units of symbols. Here, a method of calculating kₛ and k_{factor} used in Equation 2 will be described. In the following description, an example of a case where the slot length is 1 ms, the frame rate is 120 Hz, and the update interval (update period) of the frame is 8.333 ms will be described. Here, the frame rate may be sent from an upper layer of Layer 2 or higher to the control unit 11, which executes control of Layer 1 (physical layer). Furthermore, the gNB 40 may receive the frame rate from, for example, a core network node. Alternatively, the gNB 40 may learn or estimate the frame rate from the data packet arrival interval.

The control unit 11 calculates kₛ and k_{factor} by deriving by division the number of slots per second using the frame rate of the data and further dividing the numerator and the denominator using the greatest common divisor of the values of the numerator and the denominator.

Specifically, kₛ×k_{factor}=1000 (slot)/120 (frame)=25/3 is assumed. In this case, kₛ=25 slots and k_{factor}=⅓ are specified. Alternatively, in a case where kₛ×(1/k_{factor})=25/3 is assumed, k_{factor}=3 may be specified. The following description will be provided, assuming kₛ×k_{factor}=25/3.

Here, in a case where the number of symbols per slot is 14, the period in units of symbols is 117 as described below.

$$[ {k}_{factor} \cdot {k}_{s} \cdot {N}_{symb}^{slot} ] = 117$$

The period of 117 symbols is 8.357 ms. That is, in a case where the offset in units of symbols is set to 0 symbol, the control unit 11 of the gNB 40 corresponding to the communication apparatus 10 sets the PDCCH in symbol #0, symbol #117, and symbol #234 with symbol #0 at the head of the period kₛ as a reference. In addition, the control unit 22 of the UE 30 monitors the PDCCH using the section of the symbols having the duration Tₛ as the search space set with symbol #0, symbol #117, and symbol #234 as heads. #0, #117, and #234 indicate symbol numbers for identifying 25×14=350 symbols included in the period kₛ. In the period kₛ, symbols #0 to #349 are defined.

Therefore, the periods of the transmission opportunity of the PDCCH transmitted from the gNB 40 to the UE 30 are 117 symbols from symbols #0 to #116, 117 symbols from symbols #117 to #233, and 116 symbols from symbols #234 to #349.

117 symbols are 8.357 ms, 116 symbols are 8.286 ms, and in the period kₛ, PDCCH scheduling every 8.33 ms on average is possible.

As a result, the gNB 40 can schedule the PDCCH at substantially the same time as the update interval of the frame of 8.333 ms in a case where the frame rate is 120 Hz. In addition, since the UE 30 can also detect the PDCCH every 8.33 ms on average in the period kₛ, a jitter occurring in the radio section can be reduced. If the UE 30 monitors a search space set determined with a predetermined position as a head position in all slots, the base station also needs to set the PDCCH at a position corresponding to the search space. Therefore, since it takes time to schedule data after the data is updated, a jitter or a delay occurs between the data generation timing and the data transmission timing.

Here, since the PDCCH is set in symbol #0 in the period kₛ, the period (or interval) starting from symbol #234 has 116 symbols, not 117 symbols. That is, by combining the 117 symbols determined as the period in units of symbols and the period in units of slots, the first position of the symbol for which the PDCCH is set in the period kₛ can be fixed to #0. If only 117 symbols defined as the period in units of symbols are used, the first position of the symbol for which the PDCCH is set in the period kₛ is shifted to #1, #2, . . . . In this case, the data generation timing according to the frame rate does not match the position of the symbol for which the PDCCH is set, and a jitter occurs in the data transmitted between the UE 30 and the gNB 40. That is, by combining the 117 symbols determined as the period in units of symbols and the period in units of slots, it is possible to prevent a jitter from occurring or increasing in the data transmitted between the UE 30 and the gNB 40.

The communication unit 12 of the gNB 40 transmits the values of kₛ and k_{factor} to the UE 30. Alternatively, the communication unit 12 may transmit the values of kₛ and the period in units of symbols to the UE 30.

The example of the case where the slot length is 1 ms, the frame rate is 120 Hz, and the update interval (update period) of the frame is 8.333 ms has been described above, and another example will be described here. Specifically, a case where the slot length is 0.5 ms, the frame rate is 144 Hz, and the update period of the frame is 6.944 ms will be described.

In this case, kₛ is 125 slots, and k_{factor} is 1/9. Furthermore, in a case where the number of symbols per slot is 14 symbols, the period in units of symbols is 195 symbols (6.96 ms). In addition, the gNB 40 sets the PDCCH in symbol #0, symbol #195, symbol #390, symbol #585, symbol #780, symbol #975, symbol #1170, symbol #1365, and symbol #1560 with symbol #0 at the head of the period kₛ as a reference. In addition, the control unit 22 of the UE 30 monitors the PDCCH using the section of the symbols having the duration Tₛ as the search space set with symbol #0, symbol #195, symbol #390, symbol #585, symbol #780, symbol #975, symbol #1170, symbol #1365, and symbol #1560 as heads.

Furthermore, the period of the transmission opportunity of the PDCCH transmitted from the gNB 40 to the UE 30 is 195 symbols in a case where symbol #0, symbol #195, symbol #390, symbol #585, symbol #780, symbol #975, symbol #1170, and symbol #1365 are set as heads. On the other hand, in a case where symbol #1560 is set as a head, the period is 190 symbols.

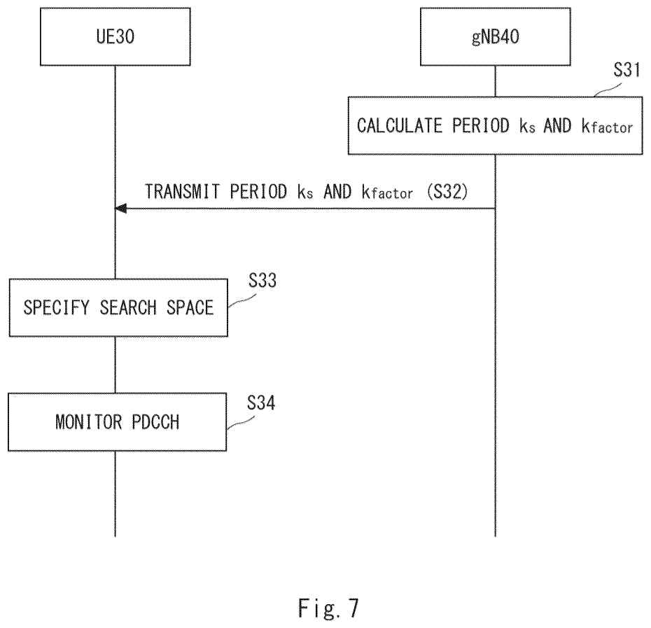

Next, a procedure of communication processing between the UE 30 and the gNB 40 will be described with reference to FIG. 7. First, the gNB 40 calculates the values of the period kₛ and k_{factor} using the slot length and the frame rate of the data (S31). Subsequently, the gNB 40 transmits the values of the period kₛ and k_{factor} to the UE 30 (S32). At this time, the gNB 40 may further transmit the start slot (offset in units of slots) of the period kₛ, the offset in units of OFDM symbols, and T_{symb} to the UE 30.

For example, the gNB 40 may transmit the period kₛ and k_{factor} to the UE 30 using higher layer signaling. The higher layer signaling may be, for example, a signaling message transmitted to the UE 30 in a medium access control (MAC) layer or a layer higher than the MAC layer, and may be, for example, an RRC message. The gNB 40 may set the period kₛ and k_{factor} in RRC information elements set in the RRC message and transmit the period kₛ and k_{factor} to the UE 30. The RRC information element may be, for example, a Search Space information element set in the RRC message. More specifically, the periods kₛ and k_{factor} may be set in monitoringSlotPeriodicity AndOffset or other parameters included in the Search Space information element. The RRC message may be a message for a specific UE, or may be system information for all UEs.

Alternatively, the gNB 40 may transmit a physical broadcast channel (PBCH) including an MIB including the period kₛ and k_{factor} to the UE 30. Alternatively, in a case where receiving a RACH preamble from the UE 30, the gNB 40 may transmit a RACH response including the period kₛ and k_{factor} to the UE 30.

The start slot (offset in units of slots) of the period kₛ, the offset in units of OFDM symbols, and T_{symb} may be transmitted to the UE 30 together with the period kₛ and k_{factor}. Alternatively, the start slot (offset in units of slots) of the period kₛ, the offset in units of OFDM symbols, and T_{symb} may be transmitted to the UE 30 using a message, a channel, or a parameter different from those of the period kₛ and k_{factor}.

In addition, in a case where the UE 30 transmits uplink data, the UE 30 recognizes the data generation timing or the data transmission timing. Therefore, the UE 30 may send the desired start slot (offset in units of slots) of the period kₛ and offset in units of OFDM symbols to the gNB 40 in accordance with the data generation timing or the data transmission timing. For example, the UE 30 may transmit the desired offset in units of slots and offset in units of OFDM symbols to the gNB 40 using a MAC control element (MAC CE).

The gNB 40 may update or reconfigure the BWP using the information regarding the offset received from the UE 30. Alternatively, the gNB 40 may apply the offset desired by the UE 30 by performing BWP Switching or SSSG (Search Space Set Switching) for switching to the search space in which the offset desired by the UE 30 is set. The gNB 40 may transmit the information regarding the updated offset or the like in step S32.

Subsequently, the control unit 22 of the UE 30 specifies the search space by applying the information received from the gNB 40 to Equation 2 (S33). Specifically, the control unit 22 specifies

$${n}_{symb , k}^{μ}$$

as the head position of the search space, and specifies, as the search space, the space of T_{symb} indicating the number of symbols of the reception opportunity of the PDCCH starting from the head position of the search space. In addition, during specifying the head position of the search space, the control unit 22 also specifies the frame number and the slot number including the head position of the search space.

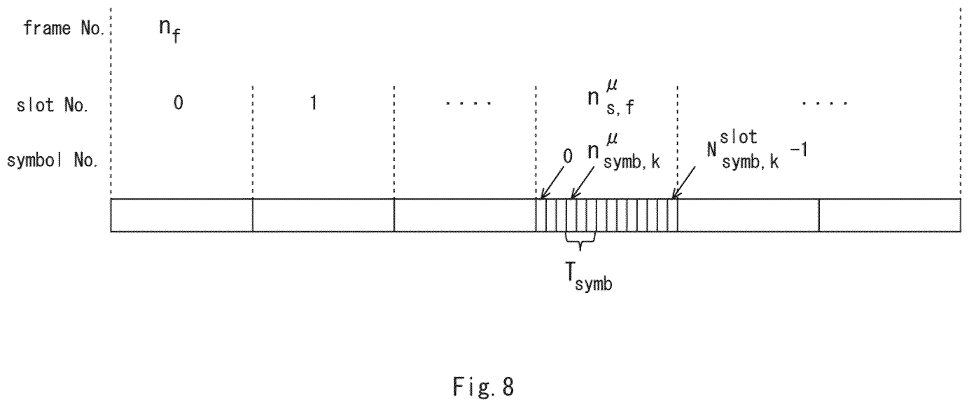

Subsequently, the control unit 22 of the UE 330 monitors the PDCCH in the specified search space (S34). Here, the search space monitored by the UE 30 will be described with reference to FIG. 8.

FIG. 8 illustrates that the frame number (frame No.) n_{f} includes a plurality of slots. In addition, FIG. 8 illustrates that the slot number (slot No.) of the search space specified using Equation 2 is

$${n}_{s , f}^{μ} ,$$

and the symbol that is the head position of the search space is

$${n}_{symb , k}^{μ} .$$

FIG. 8 illustrates that the offset in units of OFDM symbols is three symbols and T_{symb} is three symbols.

As described above, the gNB 40 calculates the period kₛ and k_{factor} by using the slot length and the frame rate of the data. The gNB 40 determines the symbol position for transmitting the PDCCH using the period kₛ and k_{factor}. The UE 30 specifies the search space for monitoring the PDCCH using the period kₛ and k_{factor}.

The period in units of slot and the period in units of symbols specified using the slot length and the frame rate are closer to the update period of the data determined on the basis of the frame rate. Therefore, a jitter in the data transmitted between the UE 30 and the gNB 40 can be reduced. Specifically, a delay between the data update period and the data transmission period can be reduced.

In addition, in a case where only the period in units of symbols is determined, the update period of the data and the period in units of symbols differ from each other, and a jitter in the data increases. On the other hand, in the second example embodiment, the symbol position and the search space for transmitting the PDCCH are determined using the period in units of slots and the period in units of symbols. As a result, since the difference between the update period of the data and the period in units of symbols is corrected every period kₛ in units of slots, it is possible to prevent the jitter of the data from increasing.

### Third Example Embodiment

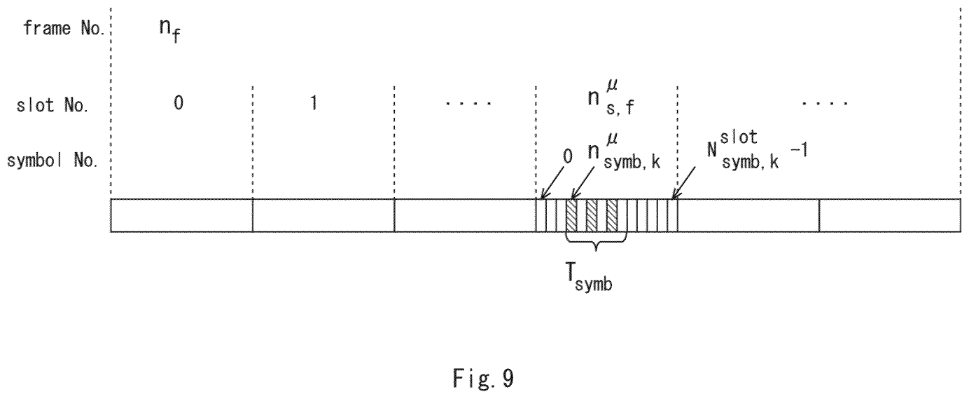

Next, the search space monitored by the UE 30 will be described with reference to FIG. 9. In FIG. 9, as well as in FIG. 8, predetermined T_{symb} starting from the symbol at the head position of the search space is set as the search space. FIG. 9 illustrates that the UE 30 attempts to detect the DCI in the symbol specified in monitoringSymbolsWithinSlot.

MonitoringSymbols WithinSlot is a parameter included in the Search Space information element of the RRC message. FIG. 9 illustrates that monitoringSymbols WithinSlot sets the positions of the shaded symbols to “1”. In FIG. 9, monitoringSymbols WithinSlot specifies that one symbol in which the UE does not attempt detection is provided between the symbols in which the UE attempts detection. For example, an example in which “10101010101010” is set in monitoringSymbolsWithinSlot indicating a 14-bit bitmap is illustrated. That is, the UE 30 attempts to detect the DCI in the symbol indicated by the portion in which 1 is set in monitoringSymbols WithinSlot within the section determined by the head position of the search space and T_{symb}.

Since the DCI detection portion described in FIG. 9 is three symbols, which is similar to the DCI detection portion described in FIG. 8, the power consumption is substantially similar to that in the processing of monitoring the search space in FIG. 8. However, in FIG. 9, T_{symb} is longer than T_{symb} in FIG. 8. Therefore, in a case where the search space monitoring processing in FIG. 9 is executed, resistance to a jitter occurring in the radio section between the UE 30 and the gNB 40 is stronger than that in a case where the search space monitoring processing in FIG. 8 is executed.

### Fourth Example Embodiment

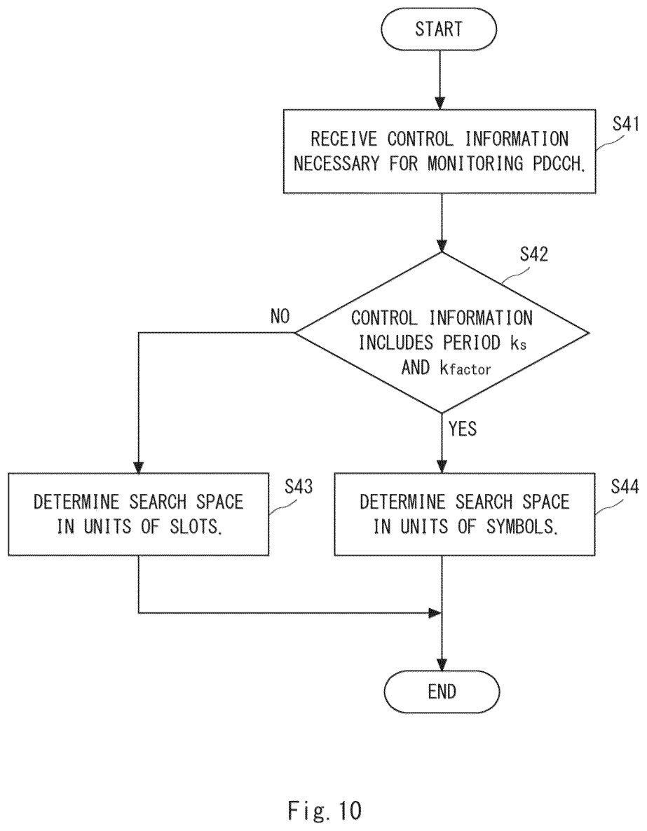

Next, processing of determining the search space in the UE 30 will be described with reference to FIG. 10. During determining the PDCCH monitoring timing, the UE 30 may choose between determining the search space in units of slots using Equation 1 and determining the search space in units of symbols using Equation 2. FIG. 10 illustrates processing in which the UE 30 determines the search space by choosing between determining the search space in units of slots and determining the search space in units of symbols.

First, the communication unit 21 of the UE 30 receives control information necessary for monitoring the PDCCH from the gNB 40 (S41). The control information necessary for monitoring the PDCCH may include, for example, the period kₛ and k_{factor}, and may further include the start slot (offset in units of slots) of the period kₛ, the offset in units of OFDM symbols, Tₛ, T_{symb}, and the like.

Subsequently, the control unit 22 of the UE 30 determines whether or not the control information includes the period kₛ and k_{factor} (S42). Alternatively, the control unit 22 may determine whether or not the control information includes k_{factor}. In a case where the control unit 22 determines that the control information does not include k_{factor}, the control unit calculates

$${n}_{s , f}^{μ} ,$$

which is the slot number in the radio frame, by using Equation 1 in order to determine the search space in units of slots (S43). Further, in a case where the control unit 22 determines that the control information includes the period kₛ and k_{factor}, or k_{factor}, the control unit determines

$${n}_{symb , k}^{μ} ,$$

which is the symbol number, by using Equation 2 in order to determine the search space in units of symbols (S44).

In this manner, the UE 30 determines the search space in units of slots or the search space in units of symbols depending on whether or not the period kₛ and k_{factor} are included in the control information or whether or not k_{factor} is included in the control information. Accordingly, the UE 30 can reliably extract the PDCCH.

As a modified example of the present example embodiment, the gNB 40 may include, in the control information transmitted to the UE 30 in S41, identification information explicitly indicating whether to determine the search space in units of slots using Equation 1 or the search space in units of symbols using Equation 2. The identification information may be, for example, 1-bit (0 or 1) information. In this case, in a case of 0, the search space in units of slots may be determined using Equation 1, and in a case of 1, the search space in units of symbols may be determined using Equation 2.

In this case, in S42, the UE 30 may choose between determining the search space in units of slots using Equation 1 or determining the search space in units of symbols using Equation 2 on the basis of the identification information included in the control information.

### Other Example Embodiments

The following Equation 3 may be used as another example of Equation 2 used to calculate the frame number, the slot number, and the symbol number indicating the head position of the search space in the second example embodiment.

$$( ( ( {n}_{f} \cdot {N}_{slot}^{frame , μ} + {n}_{s , f}^{μ} - {o}_{s} ) \cdot {N}_{symb}^{slot} + {n}_{symb , k}^{μ} - {o}_{symb} ) mod ( {k}_{s} \cdot {N}_{symb}^{slot} ) ) mod [ {k}_{factor} \cdot {k}_{s} \cdot {N}_{symb}^{slot} ] = 0 \qquad ( Equation 3 )$$

Alternatively, the following Equation 4 may be used as another example of Equation 2.

$$( ( ( {n}_{f} \cdot {N}_{slot}^{frame , μ} - {o}_{s} ) \cdot {N}_{symb}^{slot} + {n}_{symb , f}^{μ} - {o}_{symb} ) mod ( {k}_{s} \cdot {N}_{symb}^{slot} ) ) mod [ {k}_{factor} \cdot {k}_{s} \cdot {N}_{symb}^{slot} ] = 0 \qquad ( Equation 4 )$$

In addition, k_{factor} described in the second example embodiment may be indicated by using a plurality of parameters as described below.

k_{factor}=k_{factor_0}×k_{factor_1}×. . . k_{factor_n-1}

As k_{factor_n-1}, for example, values such as ½, ⅓, and ⅕ may be set.

Further, the period kₛ may be indicated by using a plurality of parameters as described below.

kₛ=k_{s_0}×k_{s_1}×. . . k_{s_m-1}

As k_{s_m-1}, values such as 1, 2, 3, and 5 may be set.

In this manner, k_{factor} or kₛ is defined using a plurality of parameters. Hence, for example, k_{factor} or kₛ can be defined by combining parameters. That is, k_{factor} or kₛ of an arbitrary value can be defined using predetermined parameters.

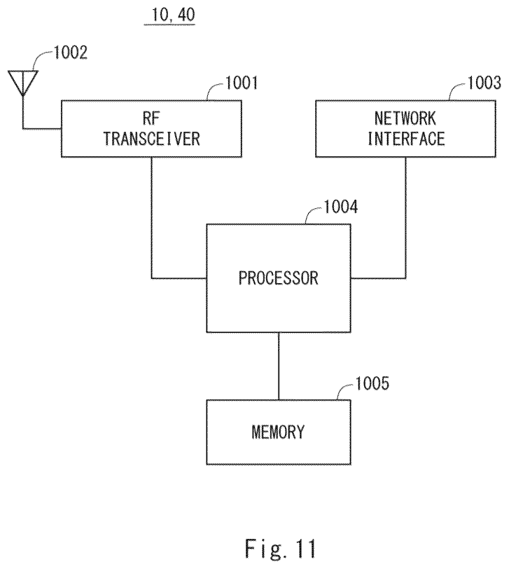

FIG. 11 is a block diagram illustrating a configuration example of the communication apparatus 10 or the gNB 40 (hereinafter, referred to as the communication apparatus 10 or the like). Referring to FIG. 11, the communication apparatus 10 or the like includes an RF transceiver 1001, a network interface 1003, a processor 1004, and a memory 1005. The RF transceiver 1001 performs analog RF signal processing to communicate with the UEs. The RF transceiver 1001 may include a plurality of transceivers. The RF transceiver 1001 is coupled with an antenna 1002 and the processor 1004. The RF transceiver 1001 receives modulated symbol data (or OFDM symbol data) from the processor 1004, generates a transmission RF signal, and supplies the transmission RF signal to the antenna 1002. Also, the RF transceiver 1001 generates a baseband reception signal on the basis of the reception RF signal received by the antenna 1002, and provides the baseband reception signal to the processor 1004.

The network interface 1003 is used to communicate with a network node (for example, another core network node). The network interface 1003 may include, for example, a network interface card (NIC) conforming to IEEE 802.3 series.

The processor 1004 performs data plane processing including digital baseband signal processing for wireless communication and control plane processing.

The processor 1004 may include a plurality of processors. For example, the processor 1004 may include a modem processor (for example, DSP) that performs digital baseband signal processing and a protocol stack processor (for example, CPU or MPU) that performs control plane processing.

The memory 1005 is configured by a combination of a volatile memory and a nonvolatile memory. The memory 1005 may include a plurality of physically independent memory devices. The volatile memory is, for example, a Static Random Access Memory (SRAM), a Dynamic RAM (DRAM), or a combination thereof. The nonvolatile memory is a masked Read Only Memory (MROM), an Electrically Erasable Programmable ROM (EEPROM), a flash memory, a solid state drive (SSD), or a hard disk drive, or any combination thereof. The memory 1005 may include a storage disposed away from the processor 1004. In this case, the processor 1004 may access the memory 1005 through the network interface 1003 or an I/O interface that is not illustrated.

The memory 1005 may store a software module (computer program) including a group of instructions and data for performing processing by the communication apparatus 10 or the like described in the example embodiments as described above. In some implementations, the processor 1004 may be configured to perform the processing of the base station 10 or the like described in the example embodiments as described above by reading the software module from the memory 1005 and executing it.

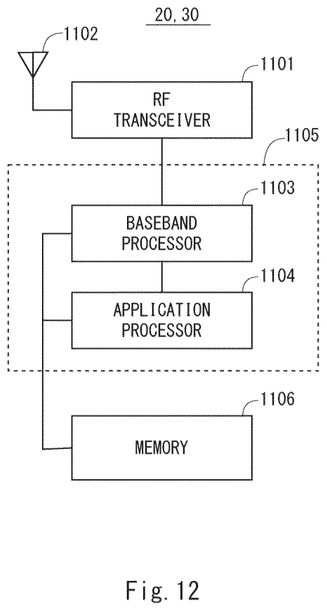

FIG. 12 is a block diagram illustrating a configuration example of the communication terminal 20 or the UE 30 (hereinafter, referred to as the communication terminal 20 or the like). A radio frequency (RF) transceiver 1101 performs analog RF signal processing to communicate with the communication apparatus 10 or the gNB 40. The analog RF signal processing performed by the RF transceiver 1101 includes frequency up-conversion, frequency down-conversion, and amplification. The RF transceiver 1101 is coupled with an antenna 1102 and a baseband processor 1103. That is, the RF transceiver 1101 receives modulated symbol data (or OFDM symbol data) from the baseband processor 1103, generates a transmission RF signal, and supplies the transmission RF signal to the antenna 1102. In addition, the RF transceiver 1101 generates a baseband reception signal on the basis of a reception RF signal received by the antenna 1102 and provides the baseband reception signal to the baseband processor 1103.

The baseband processor 1103 performs digital baseband signal processing (data plane processing) and control plane processing for wireless communication. The digital baseband signal processing includes (a) data compression/restoration, (b) data segmentation/concatenation, (c) generation/decomposition of a transmission format (transmission frame), (d) transmission path encoding/decoding, (e) modulation (symbol mapping)/demodulation, (f) generation of OFDM symbol data (baseband OFDM signal) by Inverse Fast Fourier Transform (IFFT), and the like. On the other hand, the control plane processing includes communication management of Layer 1, Layer 2, and Layer 3.

The baseband processor 1103 may include a modem processor (for example, a digital signal processor (DSP)) that performs digital baseband signal processing and a protocol stack processor (for example, a central processing unit (CPU), or a micro processing unit (MPU)) that performs control plane processing. In this case, the protocol stack processor that performs the control plane processing may be integrated with an application processor 1104 described later.

The application processor 1104 is also referred to as a CPU, an MPU, a microprocessor, or a processor core. The application processor 1104 may include a plurality of processors (a plurality of processor cores). The application processor 1104 fulfills various functions of the communication terminal 20 or the like by executing a system software program (operating system (OS)) and various application programs (for example, a call application, a WEB browser, a mailer, a camera operation application, or a music playback application) read from a memory 1106 or a memory that is not illustrated.

In some implementations, as indicated by a dashed line (1105) in FIG. 11, the baseband processor 1103 and the application processor 1104 may be integrated on one chip. In other words, the baseband processor 1103 and the application processor 1104 may be implemented as one system on chip (SoC) device 1105. The SoC device may also be referred to as a system large scale integration (LSI) or chipset.

The memory 1106 is a volatile memory, a nonvolatile memory, or a combination thereof. The memory 1106 may include a plurality of physically independent memory devices. The volatile memory is, for example, a Static Random Access Memory (SRAM), a Dynamic RAM (DRAM), or a combination thereof. The nonvolatile memory is a masked Read Only Memory (MROM), an Electrically Erasable Programmable ROM (EEPROM), a flash memory, a solid state drive (SSD), or a hard disk drive, or any combination thereof. For example, the memory 1106 may include an external memory device accessible from the baseband processor 1103, the application processor 1104, and the SoC 1105. The memory 1106 may include an embedded memory device integrated in the baseband processor 1103, in the application processor 1104, or in the SoC 1105. Further, the memory 1106 may include a memory in a universal integrated circuit card (UICC).

The memory 1106 may store a software module (computer program) including a group of instructions and data for performing processing by the communication terminal 20 or the like described in the example embodiments as described above. In some implementations, the baseband processor 1103 or the application processor 1104 may be configured to perform processing of the communication terminal 20 or the like described in the example embodiments as described above by reading the software module from the memory 1106 and executing it.

In the above-described example, the program includes a group of instructions (or software code) for causing a computer to execute one or more functions described in the example embodiments in a case where the program is read by the computer. The program may be stored in a non-transitory computer-readable medium or a tangible storage medium. By way of example, and not limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, the transitory computer-readable medium or the communication medium includes an electric, optical, acoustic, or another form of propagated signal.

Although the present disclosure has been described with reference to the example embodiments, the present disclosure is not limited to the example embodiments described above. Various modifications that can be understood by those skilled in the art can be made to the configurations and details of the present disclosure within the scope of the present disclosure. Each example embodiment can be appropriately combined with another example embodiment.

Each drawing is merely illustrative for describing one or more example embodiments. Each drawing is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps shown in any one of the drawings for describing example embodiments are not necessarily mandatory, and some features or steps may be omitted. The order of the steps described in any drawing may be changed as appropriate.

Some or all of the above-described example embodiments may be described as in the following Supplementary Notes, but are not limited to the following Supplementary Notes.

### (Supplementary Note 1)

A communication apparatus including
a control unit configured to determine, by using a slot length of a slot included in a radio frame and a frame rate of data, a first period with the slot used as a unit and a second period with a symbol included in the slot used as a unit, and determine, by using the first period and the second period, a symbol number for transmitting scheduling information of the data, and
a communication unit configured to transmit the first period and a value related to the second period to a communication terminal.

### (Supplementary Note 2)

The communication apparatus according to supplementary note 1, in which the control unit determines the first period and the value related to the second period by dividing the number of the slots included in the radio frame in a predetermined section by a value of the frame rate.

### (Supplementary Note 3)

The communication apparatus according to supplementary note 2, in which the control unit sets a value obtained by dividing the number of slots by the value of the frame rate as kₛ×k_{factor}, sets kₛ indicating a value of a numerator as the first period, and sets a value of k_{factor} as the value related to the second period.

### (Supplementary Note 4)

The communication apparatus according to supplementary note 2 or 3, in which the communication unit transmits the kₛ and the k_{factor} to a communication terminal that is a transmission destination of the data.

### (Supplementary Note 5)

The communication apparatus according to any one of supplementary notes 2 to 4, in which the control unit sets a value obtained by multiplying the value obtained by dividing the number of slots by the value of the frame rate by the number of the symbols included in the slot as the second period.

### (Supplementary Note 6)

The communication apparatus according to any one of supplementary notes 1 to 5, in which the control unit applies the first period and the second period to

$$( ( ( {n}_{f} \cdot {N}_{slot}^{frame , μ} + {n}_{s , f}^{μ} - {o}_{s} ) mod {k}_{s} ) \cdot {N}_{symb}^{slot} + {n}_{symb , k}^{μ} - {o}_{symb} ) mod [ {k}_{factor} \cdot {k}_{s} \cdot {N}_{symb}^{slot} ] = 0$$

to determine the symbol number.

### (Supplementary Note 7)

The communication apparatus according to any one of supplementary notes 1 to 5, in which the control unit applies the first period and the second period to

$$( ( ( {n}_{f} \cdot {N}_{slot}^{frame , μ} + {n}_{s , f}^{μ} - {o}_{s} ) \cdot {N}_{symb}^{slot} + {n}_{symb , k}^{μ} - {o}_{symb} ) mod ( {k}_{s} \cdot {N}_{symb}^{slot} ) ) mod [ {k}_{factor} \cdot {k}_{s} \cdot {N}_{symb}^{slot} ] = 0$$

to determine the symbol number.

### (Supplementary Note 8)

The communication apparatus according to any one of supplementary notes 1 to 5, in which the control unit applies the first period and the second period to

$$( ( ( {n}_{f} \cdot {N}_{slot}^{frame , μ} - {o}_{s} ) \cdot {N}_{symb}^{slot} + {n}_{symb , f}^{μ} - {o}_{symb} ) mod ( {k}_{s} \cdot {N}_{symb}^{slot} ) ) mod [ {k}_{factor} \cdot {k}_{s} \cdot {N}_{symb}^{slot} ] = 0$$

to determine the symbol number.

### (Supplementary Note 9)

A communication terminal including
a communication unit configured to receive a first period with a slot included in a radio frame used as a unit and a value related to a second period with a symbol included in the slot as a unit, and
a control unit configured to determine, by using the first period and the second period specified on a basis of the value related to the second period, a symbol number for receiving scheduling information of data,
in which the communication unit receives the scheduling information in the symbol number.

### (Supplementary Note 10)

The communication terminal according to supplementary note 9, in which the control unit determines whether or not the value related to the second period has been received, and determines the symbol number in a case where the value related to the second period has been received.

### (Supplementary Note 11)

A communication system including
a communication apparatus including a communication unit configured to determine, by using a slot length of a slot included in a radio frame and a frame rate of data, a first period with the slot used as a unit and a second period with a symbol included in the slot used as a unit, determine, by using the first period and the second period, a symbol number for transmitting scheduling information of the data, and transmit the first period and a value related to the second period, and
a communication terminal configured to receive the first period and the value related to the second period, determine, by using the first period and the second period specified on a basis of the value related to the second period, the symbol number for receiving the scheduling information of the data, and receive the scheduling information in the symbol number.

### (Supplementary Note 12)

The communication system according to supplementary note 11, in which the communication apparatus determines the first period and the value related to the second period by dividing the number of the slots included in the radio frame in a predetermined section by a value of the frame rate.

### (Supplementary Note 13)

A communication method executed in a communication apparatus, the communication method including
determining, by using a slot length of a slot included in a radio frame and a frame rate of data, a first period with the slot used as a unit and a second period with a symbol included in the slot used as a unit,
determining, by using the first period and the second period, a symbol number for transmitting scheduling information of the data, and
transmitting the first period and a value related to the second period to a communication terminal.

### (Supplementary Note 14)

The communication method according to supplementary note 13, in which, during the first period and the second period are determined, the first period and the value related to the second period are determined by dividing the number of the slots included in the radio frame in a predetermined section by a value of the frame rate.

### (Supplementary Note 15)

The communication method according to supplementary note 14, in which, during the first period and the second period are determined, a value obtained by dividing the number of slots by the value of the frame rate is set as kₛ×k_{factor}, kₛ indicating a value of a numerator is set as the first period, and a value of k_{factor} is set as the value related to the second period.

### (Supplementary Note 16)

The communication method according to supplementary note 14 or 15, in which, during the first period and the value related to the second period are transmitted to the communication terminal, the kₛ and the k_{factor} are transmitted to the communication terminal that is a transmission destination of the data.

### (Supplementary Note 17)

The communication method according to supplementary note 14 or 15, in which, during the first period and the second period are determined, a value obtained by multiplying the value obtained by dividing the number of slots by the value of the frame rate by the number of the symbols included in the slot is set as the second period.

### (Supplementary Note 18)

A communication method executed in a communication terminal, the communication method including
receiving a first period with a slot included in a radio frame used as a unit and a value related to a second period with a symbol included in the slot as a unit,
determining, by using the first period and the second period specified on a basis of the value related to the second period, a symbol number for receiving scheduling information of data, and
receiving the scheduling information in the symbol number.

### (Supplementary Note 19)

A program configured to cause a computer to execute
determining, by using a slot length of a slot included in a radio frame and a frame rate of data, a first period with the slot used as a unit and a second period with a symbol included in the slot used as a unit,
determining, by using the first period and the second period, a symbol number for transmitting scheduling information of the data, and
transmitting the first period and a value related to the second period to a communication terminal.

### (Supplementary Note 20)

A program configured to cause a computer to execute
receiving a first period with a slot included in a radio frame used as a unit and a value related to a second period with a symbol included in the slot as a unit,
determining, by using the first period and the second period specified on a basis of the value related to the second period, a symbol number for receiving scheduling information of data, and
receiving the scheduling information in the symbol number.

Some or all of the elements (such as components and functions, for example) described in supplementary notes 2 to 8 dependent on supplementary note 1 may be dependent on supplementary notes 11, 13, and 19 as well with similar dependent relationships to those of supplementary notes 2 to 8. In addition, some or all of the elements (such as components and functions, for example) described in supplementary note 10 dependent on supplementary note 9 may be dependent on supplementary notes 11, 18, and 20 as well with a similar dependent relationship to that of supplementary note 10. Some or all of the elements described in any supplementary note may be applied to various types of hardware, software, recording means for recording software, systems, and methods.

This application claims priority based on Japanese Patent Application No. 2022-171841 filed on Oct. 26, 2022, the entire disclosure of which is incorporated herein.

### REFERENCE SIGNS LIST

10 COMMUNICATION APPARATUS
11 CONTROL UNIT
12 COMMUNICATION UNIT
20 COMMUNICATION TERMINAL
21 COMMUNICATION UNIT
22 CONTROL UNIT
30 UE
40 gNB

What is claimed is:

1. A communication apparatus comprising:
at least one memory storing instructions; and
at least one processor configured to execute the instructions to;
determine, by using a slot length of a slot included in a radio frame and a frame rate of data, a first period with the slot used as a unit and a second period with a symbol included in the slot used as a unit, and determine, by using the first period and the second period, a symbol number for transmitting scheduling information of the data; and
transmit the first period and a value related to the second period to a communication terminal.

2. The communication apparatus according to claim 1, wherein the at least one processor is further configured to execute the instructions to determine the first period and the value related to the second period by dividing the number of the slots included in the radio frame in a predetermined section by a value of the frame rate.

3. The communication apparatus according to claim 2, wherein the at least one processor is further configured to execute the instructions to set a value obtained by dividing the number of slots by the value of the frame rate as kₛ×k_{factor}, sets kₛ indicating a value of a numerator as the first period, and set a value of k_{factor} as the value related to the second period.

4. The communication apparatus according to claim 3, wherein the at least one processor is further configured to execute the instructions to transmit the kₛ and the k_{factor} to a communication terminal that is a transmission destination of the data.

5. The communication apparatus according to claim 2, wherein the at least one processor is further configured to execute the instructions to set a value obtained by multiplying the value obtained by dividing the number of slots by the value of the frame rate by the number of the symbols included in the slot as the second period.

6. The communication apparatus according to claim 1, wherein the at least one processor is further configured to execute the instructions to apply the first period and the second period to
$$( ( ( {n}_{f} \cdot {N}_{slot}^{frame , μ} + {n}_{s , f}^{μ} - {o}_{s} ) mod {k}_{s} ) \cdot {N}_{symb}^{slot} + {n}_{symb , k}^{μ} - {o}_{symb} ) mod [ {k}_{factor} \cdot {k}_{s} \cdot {N}_{symb}^{slot} ] = 0$$
to determine the symbol number.

7. The communication apparatus according to claim 1, wherein the at least one processor is further configured to execute the instructions to apply the first period and the second period to
$$( ( ( {n}_{f} \cdot {N}_{slot}^{frame , μ} + {n}_{s , f}^{μ} - {o}_{s} ) \cdot {N}_{symb}^{slot} + {n}_{symb , k}^{μ} - {o}_{symb} ) mod ( {k}_{s} \cdot {N}_{symb}^{slot} ) ) mod [ {k}_{factor} \cdot {k}_{s} \cdot {N}_{symb}^{slot} ] = 0$$
to determine the symbol number.

8. The communication apparatus according to claim 1, wherein the at least one processor is further configured to execute the instructions to apply the first period and the second period to
$$( ( ( {n}_{f} \cdot {N}_{slot}^{frame , μ} - {o}_{s} ) \cdot {N}_{symb}^{slot} + {n}_{symb , f}^{μ} - {o}_{symb} ) mod ( {k}_{s} \cdot {N}_{symb}^{slot} ) ) mod [ {k}_{factor} \cdot {k}_{s} \cdot {N}_{symb}^{slot} ] = 0$$
to determine the symbol number.

9. A communication terminal comprising:
at least one memory storing instructions; and
at least one processor configured to execute the instructions to;
receive a first period with a slot included in a radio frame used as a unit and a value related to a second period with a symbol included in the slot as a unit;
determine, by using the first period and the second period specified on a basis of the value related to the second period, a symbol number for receiving scheduling information of data; and
receive the scheduling information in the symbol number.

10. The communication terminal according to claim 9, wherein the at least one processor is further configured to execute the instructions to determine whether or not the value related to the second period has been received, and determine the symbol number in a case where the value related to the second period has been received.

11-12. (canceled)

13. A communication method executed in a communication apparatus, the communication method comprising:
determining, by using a slot length of a slot included in a radio frame and a frame rate of data, a first period with the slot used as a unit and a second period with a symbol included in the slot used as a unit;
determining, by using the first period and the second period, a symbol number for transmitting scheduling information of the data; and
transmitting the first period and a value related to the second period to a communication terminal.

14. The communication method according to claim 13, wherein, during the first period and the second period are determined, the first period and the value related to the second period are determined by dividing the number of the slots included in the radio frame in a predetermined section by a value of the frame rate.

15. The communication method according to claim 14, wherein, during the first period and the second period are determined, a value obtained by dividing the number of slots by the value of the frame rate is set as kₛ×k_{factor}, kₛ indicating a value of a numerator is set as the first period, and a value of k_{factor} is set as the value related to the second period.

16. The communication method according to claim 15, wherein, during the first period and the value related to the second period are transmitted to the communication terminal, the kₛ and the k_{factor} are transmitted to the communication terminal that is a transmission destination of the data.

17. The communication method according to claim 14, wherein, during the first period and the second period are determined, a value obtained by multiplying the value obtained by dividing the number of slots by the value of the frame rate by the number of the symbols included in the slot is set as the second period.

18.-20. (canceled)
